(19) United States
(12) Patent Application Publication
(10) Pub. No.: US 2016/0209490 A1
(43) Pub. Date: Jul. 21, 2016

(54) ANTENNA DEVICE FOR RF POSITIONING SYSTEM AND INSTALLATION METHOD THEREOF

(71) Applicant: Su-Teng KUO, New Taipei City (TW)

(72) Inventor: Su-Teng KUO, New Taipei City (TW)

(21) Appl. No.: 14/988,767

(22) Filed: Jan. 6, 2016

Related U.S. Application Data
(60) Provisional application No. 62/104,694, filed on Jan. 17, 2015.

(51) Int. Cl. G01S 5/02; H01Q 9/04; H01Q 1/00

(52) U.S. Cl. CPC G01S 5/0252; G01S 5/0294; H01Q 1/007; H01Q 9/0428; H01Q 9/0407

(57) ABSTRACT

The present invention discloses a positioning system based on Received Signal Strength having an antenna device with a directional patch antenna with circular polarization, and an installation method thereof. By having a circular polarization, being directional and of a patch design, the directional patch antenna can mitigate signal strength discrepancies caused by devices located at different angles, and signal strength interference due to presence of multi-paths, and front-end antenna radiation pattern and input impedance caused by ambient environment of the antenna device and other material compositions. Beacons are preferably installed on the ceiling, which can improve the line-of-sight (LOS) opportunities between the positioning devices and tracked objects.

### FIELD OF THE INVENTION

The present invention generally relates to an antenna device and, more particularly, to an antenna device of a directional patch design with circular polarization configured for RF positioning system.

### BACKGROUND OF THE INVENTION

Conventional positioning devices are become more popular in usage for determining accurate position or location of objects or persons in indoor and outdoor environment. The positioning device is generally equipped with an antenna with RF signal receiving capability, that is typically an omni-directional linear polarization antenna. In typical conventional beacon positioning devices, planar inverted-F antenna (PIFA) antenna is used, which is typically of linear polarization, having an axial ratio (AR) greater than 10 dB, omni-directional (with antenna directivity less than 3 dBi), and not of patch design. Conventional Beacon/iBeacon positioning devices are typically placed adjacent or next to tracked object at relatively easy to reach installation locations, rather than being placed at any particular elevated height that is difficult to reach, and as a result, are thus vulnerable to object signal blocking and experiencing negative signal interference effects due to having people (acting as obstructions) walking around the tracked object.

The antenna radiation pattern and the input impedances of the conventional antennas are negatively affected significantly by vicinity surroundings, especially from metal object. The backside of conventional RF positioning device is typically securely and affixed on to an object, which can be a displayed object or an exhibited object, a shelf corner end, walls, ceilings, etc. . . . . The radiation pattern and input impedance of typical conventional antennas are affected by the interference from the aforementioned object located at backside of the positioning device. The former will negatively affect the accuracy and stability of the usage of signal strength for distance determination, and the later will affect the radiation efficiency of the antenna.

As a result, due to the fact that conventional positioning system typically rely upon RSSI to perform triangulation positioning or fingerprinting positioning, which are subjected to be influenced by position or location of transceiver, and by taking into consideration of the significant degree of environmental impact of RF signal blocking and interferences, often resulting in poor stability of the RF signal, which led to inaccurate and unstable positioning data. Thus there is a need for improvement on the antenna design for RF indoor positioning system.

### SUMMARY OF THE INVENTION

The present invention provides a RF positioning system based on signal strength (Received Signal Strength, RSS-based) having one or more RF positioning devices, each equipped with an antenna device that is of a directional patch design with circular polarization.

The present invention provides the antenna device of the directional patch design with circular polarization with improved performance capability with respect to overall received signal strength, return loss or power loss value, input matching, shielding and positioning signal interference prevention from adjacent metal object located at close proximity to the antenna device.

The present invention also provides an installation method for the RF positioning devices for the RF positioning system to enhance the positioning accuracy and stability of tracked objects.

The antenna device for RF positioning system of embodiments of present invention can mitigate negative signal interferences such as: (a) signal strength discrepancies caused by devices located at different angles, (b) signal strength interference due to presence of multi-pathes, and front-end antenna radiation pattern and input impedance caused by ambient environment of the antenna device and other material compositions.

According to an embodiment of present invention, a positioning device such as a Beacon is preferably installed on an elevated height, such as a ceiling or a wall at a height of 3 m to 4 m (as measured from the floor to the height of the beacon) which can greatly improve the line-of-sight (LOS) opportunities between the RF positioning device and any tracked object. Thus improved line-of-sight (LOS) is one significant contributing factor to the improvement of the antenna of present invention. Through the use of affixing or mounting of the positioning device on a higher elevation/height level in contrast with conventional positioning device which are typically being placed at lower elevation/height level or near tracked object, the RF positioning device can be effectively prevented from being (inadvertently) blocked by object and people, thereby improving upon reliability of the signal strength (RSSI) used as basis for positioning determining scheme.

As a result, the antenna device and installation method thereof of the RF positioning system of present invention based upon signal strength positioning scheme can effectively improve the positioning accuracy and stability of the overall RF positioning system.

According to embodiments of present invention, the antenna device for RF positioning system has circular polarization instead of linear polarization.

According to embodiments of present invention, the antenna device for RF positioning system is a directional antenna, instead of an omni-directional antenna.

According to embodiments of present invention, the antenna device for RF positioning system is a patch antenna.

According to embodiments of present invention, the antenna device for RF positioning system has reduced sensitivity of the direction and angle of the tracked object or device.

According to embodiments of present invention, the antenna device for RF positioning system has higher antenna directivity, and thus more resistance to multipath by reflection and diffraction, and also more resistance to interference, and having more significant signal strength drop off between the RF positioning device coverage area and non-coverage area, a positioning engine using RF signal strength (RSSI, received signal strength indicator) as the measuring principle or basis can effectively enhance the positioning accuracy.

According to embodiments of present invention, the antenna device for RF positioning system being of a patch antenna pattern can be radiating toward the broadside direction only, so that a field strength difference between backlobe and broadside of the antenna may be higher than 10 dB or more. Thus the (patch) antenna device according to embodiments of present invention is capable of reducing rear/backlobe signal radiation so that the front/broadside radiation of the antenna pattern and impedance matching are not affected by the interference from the ambient environment at the rear side of the antenna device.

According to embodiments of present invention, the antenna device for RF positioning system has a substrate (by forming a grounded substrate) grounded so as to effectively shield an object located at the back of the antenna device and thus preventing interference by the object located at the back of the antenna device. The object can be a metal object.

The present invention provides improved positioning accuracy of tracked object by using more than one RF positioning devices, each equipped with the same antenna device that is of the directional patch design with circular polarization.

### BRIEF DESCRIPTION OF THE DRAWINGS

The present invention will become more readily apparent to those ordinarily skilled in the art after reviewing the following detailed description and accompanying drawings, in which:

FIG. 1 shows a block diagram of a RF positioning system according to an embodiment of present invention.

FIG. 2 shows a perspective view of an antenna device of the embodiment of present invention.

FIGS. 3A and 3B show side-by-side performance comparison between a conventional PIFA antenna device (of FIG. 3A) versus the antenna device of the embodiment of present invention (of FIG. 3B).

FIG. 4 shows antenna radiation patterns of the conventional pifa antenna device and the antenna device of the embodiment plotted with respect to x-z plane.

FIG. 5 shows experimental results obtained on signal strength data (RSSI) with respect to rotation angles of a position-tracked device for a first beacon and a second beacon (of the embodiment of present invention).

FIG. 6 shows installation locations of a group of antenna devices in a space.

### DETAILED DESCRIPTION OF PREFERRED EMBODIMENTS

The present invention will now be described more specifically with reference to the following embodiments. It is to be noted that the following descriptions of the embodiments of this invention are presented herein for purpose of illustration and description only. It is not intended to be exhaustive or to be limited to the precise form disclosed.

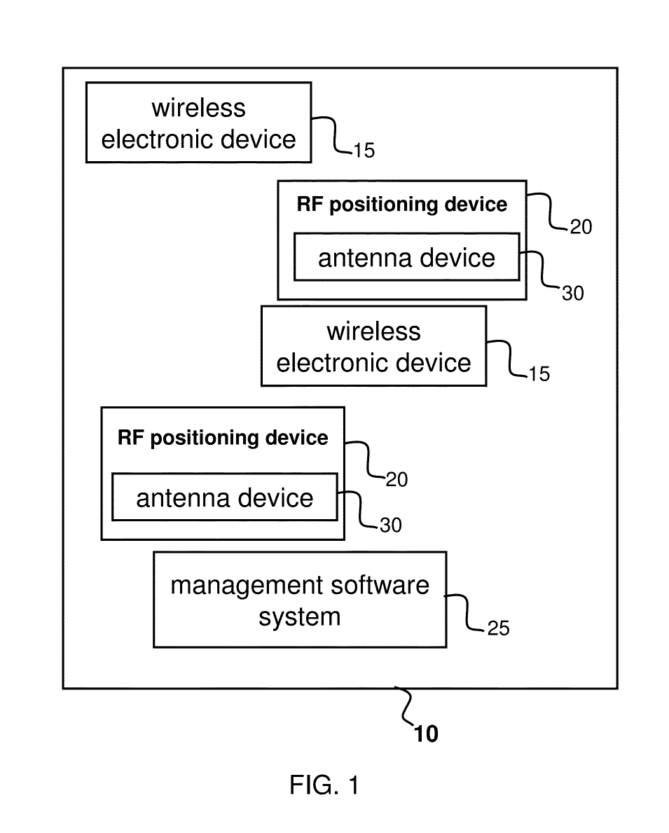

As shown in FIG. 1, a RF positioning system according to an embodiment of present invention is provided, in which the RF positioning system 10 can be an indoor or outdoor RF location estimation system with operating principle based on received signal strength (RSS) of various types of RF signals of a set frequency band. The RF positioning system 10 includes one or more wireless electronic devices 15 (whose locations thereof are being measured and tracked), one or more RF positioning devices 20, such as beacons or ibeacons, and a management software system 25 for the RF positioning system 10. The description details and/or commercial availability of the wireless electronic devices 15 and the management software system 25 for the RF positioning system 10 are available and found in various public literature or commercial positioning system products, and are thus omitted herein for the sake of brevity. Each RF positioning device 20 includes an antenna device 30 configured for receiving RF signals from the one or more wireless electronic devices 15 that are being tracked for location data. The wireless electronic device 15 is also referred to a tracked object herein, and can be a mobile phone, a smartphone, a wireless IP camera, a wireless tablet device, a laptop, and a wireless autonomous robot, but is not limited to these.

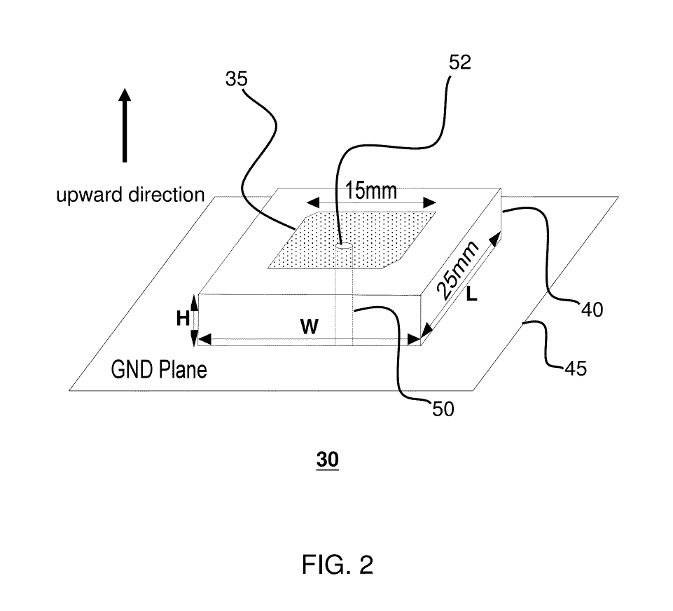

The antenna device 30 of the embodiment of present invention is shown in FIG. 2. In the illustrated embodiment, the antenna device 30 for the RF positioning system 10 has a directional patch design with circular polarization. The antenna device 30 includes a patch antenna 35, a substrate layer 40, a ground plane 45, and a probe feed 50. The ground plane 45 is a grounded dielectric layer providing shielding so that the antenna device 30 would only be radiating in an upward direction. In the illustrated embodiment, the substrate layer 40 of the antenna device 30 has a height H of 5 mm, a length L of 25 mm and a width W of 25 mm; the patch antenna 35 can be substantially square with a length of 15 mm and a width of 15 mm, respectively. The substrate layer 40 can be made of a material of dielectric constant of 5-8. The resonant frequency selected for the antenna device can be, for example, 2.4 GHz, but is not limited thereof, and can be configured also to operate between frequency range from 2.1 GHz to 5.6 GHz. The feed point 52 of the probe feed 50 is coupled to the patch antenna 35 at substantially in a center area of the patch antenna 35 at one end of the probe feed 50, while the other end of the probe feed 50 is coupled to a coaxial connector (not shown) to form a coaxial probe feed.

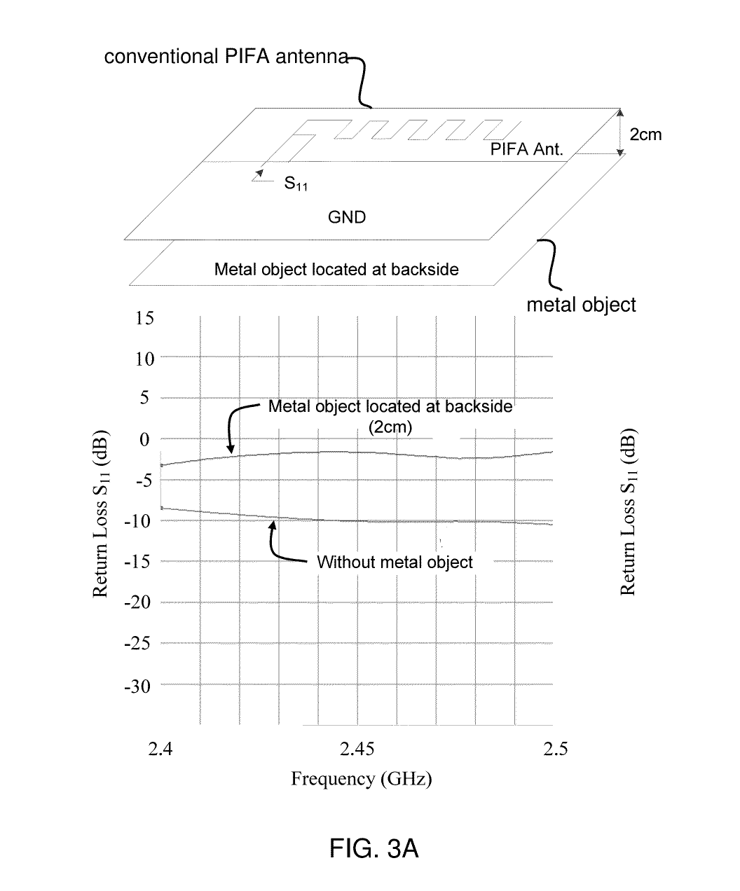

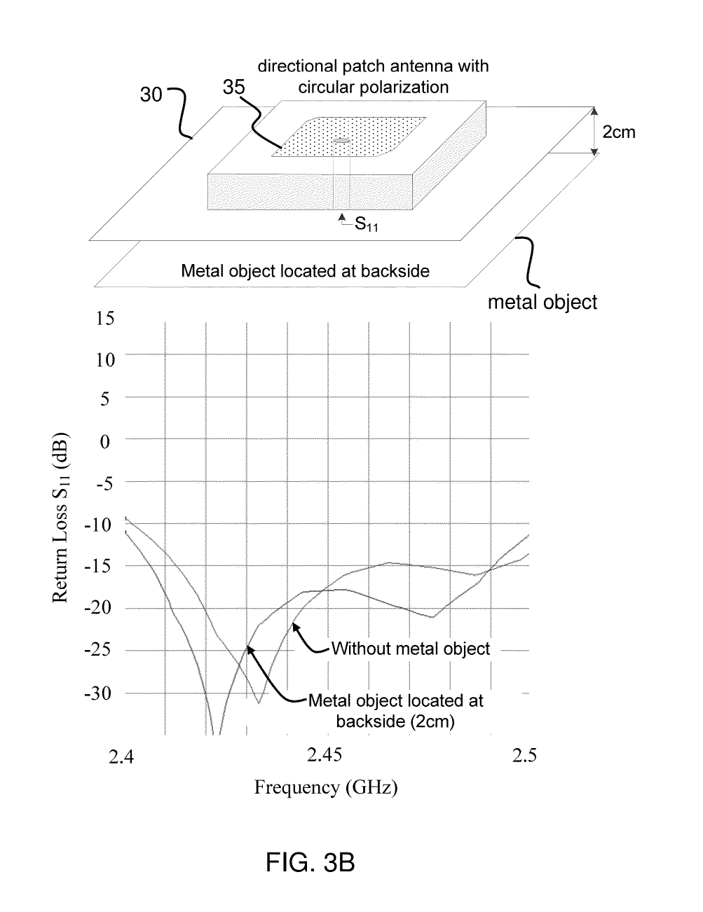

FIGS. 3A and 3B show (side-by-side) comparison between performances of a conventional PIFA antenna device (see FIG. 3A) and that of the antenna device 30 of the embodiment of present invention (see FIG. 3B), both different antennas are respectively configured at two different operating configurations or settings, in which one operating configuration/setting has a metal object disposed 2 cm at the backside of the antenna devices thereof, respectively, and the other operating configuration/setting has no metal object disposed on the backside of the antennas, based upon experiments conducted. The device structures and return loss data of a (conventional/traditional) pifa antenna in comparison with the antenna device 30 of the embodiment of present invention having the patch antenna 35 being a directional patch antenna with circular polarization of present invention are shown to be different in FIGS. 3A and 3B. The antenna device 30 effectively radiates a return loss required to be greater than −6 dB (>−6 dB). From further comparison of FIGS. 3A and 3B, it can be seen that the conventional pifa antenna device has a return loss of just −2 dB to −3 dB due to the presence of the metal object located at backside thereof at a 2 cm gap distance between the pifa antenna device and the metal object. On the other hand, the antenna device 30 (directional patch antenna with circular polarization) of the embodiment of present invention has a return loss performance of above −10 dB, with or without the metal object located at the same gap of 2 cm at the backside thereof. Thus, it is seen that the antenna device 30 (directional patch antenna with circular polarization) of present invention has significant improvement in performances including return loss, input matching and prevention of positioning signal interference by external metal object at close proximity to the antenna device.

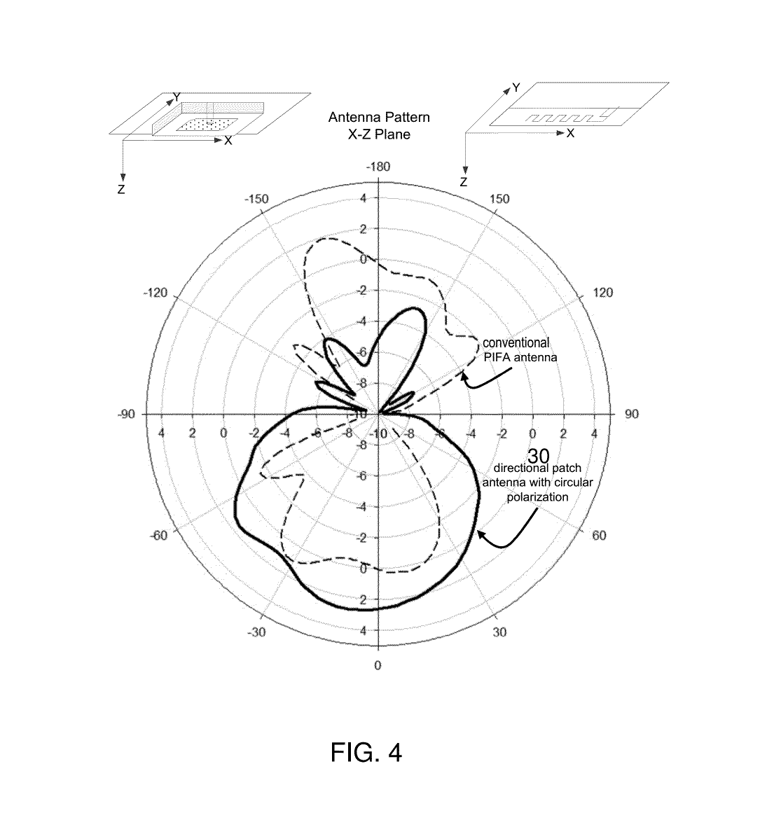

As further illustration on the behavior differences of the conventional pifa antenna device with respect to the antenna device 30 of the embodiment of present invention, a plurality of antenna radiation pattern data of the conventional pifa antenna device and the antenna device 30 of the embodiment are respectively plotted and shown in FIG. 4, in which the antenna radiation pattern data are collected and plotted with respect to x-z plane. The 3 dB beamwidth for the antenna device 30 (directional patch antenna with circular polarization) is about 60 degrees, which is less than the 3 dB beamwidth for the conventional pifa antenna device of about 80 degrees. It is appreciated by one skilled in the art that the lower angular value at 3 dB beamwidth for the antenna device 30 represents the fact that directivity is more pronounced or more significant in comparison with the conventional pifa antenna device in FIG. 4. In addition, the field effect on the back of the antenna device 30 is seen to be effectively suppressed.

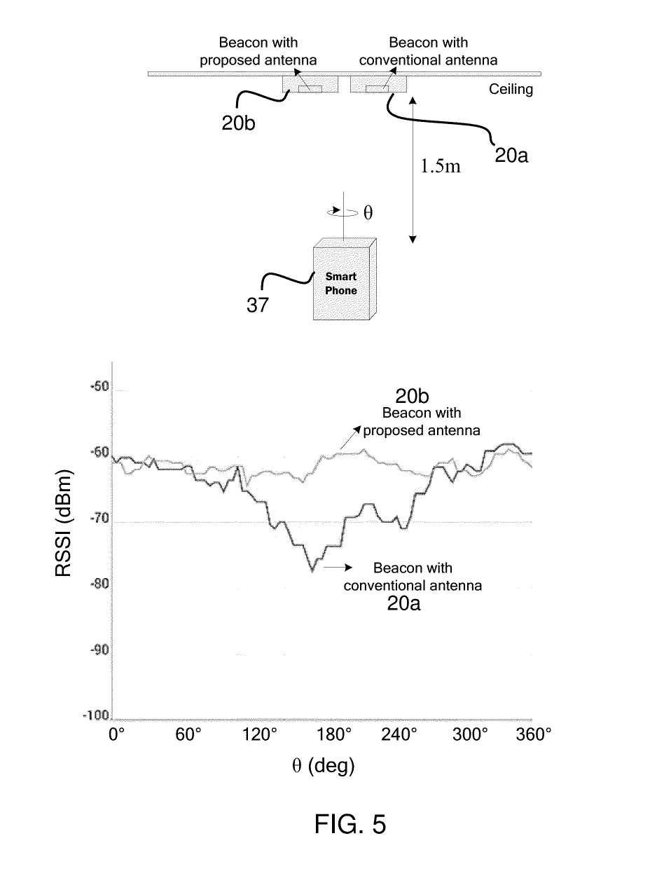

FIG. 5 shows experimental results obtained on signal strength data (RSSI) with respect to rotation angles of position-tracked device for two beacons, which include a first beacon 20a configured with a conventional pifa antenna device, and a second beacon 20b which is the RF positioning device 20 configured with the antenna device 30. The first and second beacons 20a, 20b are only different in the antenna devices used/adopted therein, while maintaining the same for the other components thereof. A smartphone 37 is rotated at various different rotation angles held underneath the respective beacons 20a, 20b. In other words, the smarthphone 37 is rotated from 0 degree to 360 degrees (full circle, θ). The beacon 20b (configured with the antenna device 30) of the embodiment of present invention (equipped with the directional patch antenna with circular polarization, herein also referred to as a beacon embodiment) is compared to the beacon 20a (equipped with the conventional pifa antenna device, herein also referred to as a conventional beacon) are (both) placed on a ceiling surface located side by side with respect to one another at close proximity (i.e. 3 cm apart). During an experiment, antenna energy from both beacons 20a and 20b are configured to be radiating downward toward the smartphone 37. The smartphone 37 is rotated around its center axis from 0 degree to 360 degrees at a distance of 1.5 meters (m) away from both beacons 20a, 20b (the embodiment beacon and the conventional beacon), respectively. At the same 1.5 meter distance to the beacons 20a, 20b, the embodiment beacon 20b achieved a power loss at about 5 dB, but the conventional beacon 20a has a more significant power loss at above 15 dB. From the experimental data shown in FIG. 5, the conventional beacon 20a seems to be inadequate in signal strength at rotation angle from about 120 degrees to about 240 degrees. Meanwhile, the embodiment beacon 20b demonstrates sufficient signal strength at all rotations angles of 0 degrees to 360 degrees for the smartphone 37.

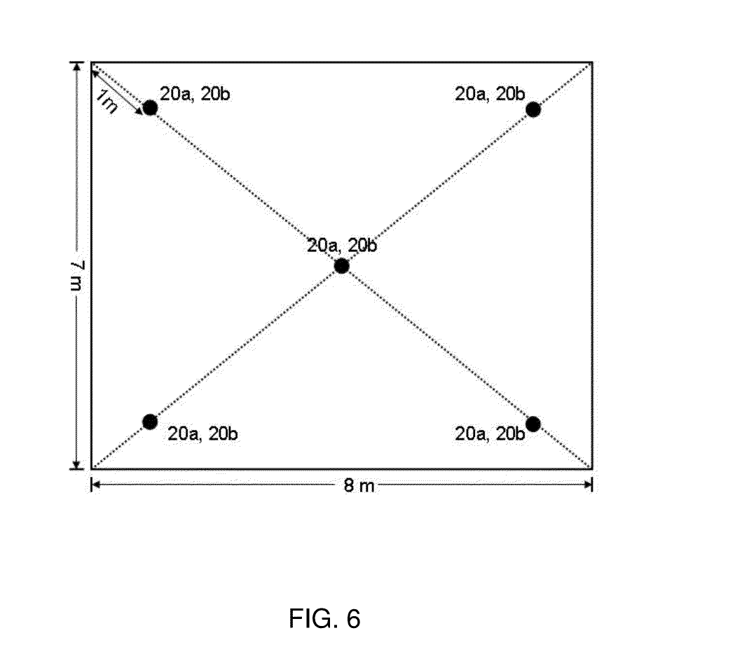

As shown in FIG. 6, further experiments are conducted using a group of 5 beacons, which have been installed in a 8 meter by 7 meter space. Each of the 5 beacons used in the conducted experiments are either all conventional beacons 20a or all embodiment beacons 20b, disposed at same respective mounting locations. The first and second beacons 20a, 20b are only different with respect to the antenna devices configured therein (i.e. conventional beacon versus embodiment beacon), while maintaining the same specifications for the other components thereof. An installation method for the RF positioning devices 20 for the RF positioning system 10 to enhance the positioning accuracy and stability of tracked objects (or wireless electronic device 15), such as the smartphone 37 includes secure mounting of the 5 embodiment beacons 20b (which is same as the RF positioning devices 20) onto the 1.5 meter tall ceiling of the 8 meter by 7 meter space in the following manner: (a) mount one embodiment beacon 20b on the ceiling in the center of the 8 meter by 7 meter space, in which the center is determined by drawing two erasable diagonal lines at the intersecting point thereof; (b) mounting each of the remaining four embodiment beacons 20 on the ceiling along a diagonal line at about 1 meter away from each corner point P of the space. The patch antenna 35 of the antenna device 30 is facing downwardly toward the floor of the space.

The same smartphone (not shown) is moved around in the 8 meter by 7 meter space underneath the respective beacons 20a, 20b. During experiment, antenna energy from all 5 beacons, namely the conventional beacons 20a or the embodiment beacons 20b are configured to be radiating downward toward the smartphone 37. The results from the experiments showed that the conventional pifa antenna beacons 20a (conventional beacons) together achieved average positioning accuracy of about 3 meters for the smartphone; whereas, the embodiment beacons 20b (equipped with the directional patch antenna with circular polarization) together achieved average positioning accuracy of within 1 meter for the smartphone. Based on the experiments conducted, the embodiment beacons 20b equipped with the antenna device 30 when operating in a group configuration, i.e. 5 embodiment beacons 20b, are superior in performance in positioning accuracy of tracked object such as the smartphone than the conventional beacons 20a that are equipped with conventional pifa antenna device when also operating in the group configuration, i.e. 5 conventional beacons 20a.

Most conventional RF positioning systems based on received signal strength, operate under existing positioning infrastructure, such as for example, using a WiFi access point (AP). Under the premise of not having to modify or change existing hardware, typical conventional methods for positioning improvements are accomplished via performing of software upgrades to the positioning algorithm, which is usually performed by a professional software engineer. Meanwhile, because normally the software engineer is not an antenna expert in positioning systems, thus the software engineer would not be motivated or reasoned to attempt antenna redesign for seeking positioning accuracy improvement. Indeed, many software engineers may not realize the potential advantages of a directional patch antenna with circular polarization for use in RF positioning systems when used correctly in a properly-configured spatial arrangement of the positioning devices. As a result, embodiments of present invention provide a fully-tested antenna device that is effectively configured for use for many RF positioning devices, i.e. Beacons and iBeacons, with actual data obtained which show positioning accuracy improvements for tracking wireless electronic devices, such as a smartphone, while operating in various settings, thereby giving the knowledge and confidence to software engineers for usage adoption in their own proprietary RF positioning systems in the future. In addition, because designing, fine tuning and testing of the antenna device 30 required to be performed while operating under positioning trials (i.e., for example, while tracking smartphones inside a beacon laid-out room) in a coordinated side-by-side manner, so that each positioning improvement realized can be properly as assessed as whether belonging to antenna-device related (causes or factors) or positioning-algorithm (software) related. As a result, the degree of difficulty for accomplishing antenna redesign while conducting positioning trials is relatively high. In addition, the antenna design along with the necessary impedance matching for the circular polarization antenna device thereof adds to the overall complexity of the endeavor, while any added cost of the antenna device would also be another consideration to those skilled in the art.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An antenna device configured for a RF positioning device for a RF positioning system, comprising:
a patch antenna;
a substrate layer;
a ground plane; and
a probe feed,
wherein the antenna device is of a directional patch design with circular polarization.

2. The antenna device as claimed in claim 1, wherein the ground plane is a grounded dielectric layer providing shielding, the substrate layer has a height of 5 mm, a length of 25 mm and a width of 25 mm, and being made of a material of dielectric constant of between 5 to 8.

3. The antenna device as claimed in claim 1, wherein the patch antenna has a length of 15 mm and a width of 15 mm, respectively.

4. The antenna device as claimed in claim 1, wherein a resonant frequency for the patch antenna is 2.4 GHz

5. The antenna device as claimed in claim 1, wherein a resonant frequency for the patch antenna is between 2.1 GHz to 5.6 GHz.

6. The antenna device as claimed in claim 3, wherein the probe feed has a feed point, the feed point is coupled to the patch antenna substantially in a center area of the patch antenna.

7. The antenna device as claimed in claim 1, wherein the RF positioning device is a WiFi/BLE beacon positioning device.

8. The antenna device as claimed in claim 1, wherein the RF positioning system further comprising one or more tracked object, the one or more tracked object comprising of mobile phones, smartphones, wireless IP cameras, wireless tablet devices, laptops, and wireless autonomous robots.

9. The antenna device as claimed in claim 1, wherein the RF positioning device is a beacon, the beacon is a proprietary BLE beacon, a regular beacon, or an iBeacon™.

10. The antenna device as claimed in claim 1, wherein a 3 dB beamwidth for the antenna device is 60 degrees.

11. A positioning device for a RF positioning system for tracking positioning of one or more tracked object based on RF signal strength, comprising:
an antenna device comprising a patch antenna, a substrate layer, a ground plane, and a probe feed, the probe feed has a feed point connecting to the patch antenna,
wherein the substrate layer has a height of 5 mm, a length of 25 mm and a width of 25 mm, the patch antenna has a length of 15 mm and a width of 15 mm, the substrate layer is made of a material of dielectric constant of between 5 to 8, and the antenna device is a directional patch antenna with circular polarization.

12. The positioning device as claimed in claim 10, wherein the feed point of the probe feed is coupled to the patch antenna at substantially in a center area of the patch antenna.

13. The positioning device as claimed in claim 10, wherein the positioning device is installed at a height of 3 m to 4 m from the floor.

14. The positioning device as claimed in claim 10, wherein the patch antenna of the antenna device has a patch antenna pattern radiating toward broadside direction only, the field strength difference between backlobe and broadside of the antenna device is higher than 10 dB.

15. The positioning device as claimed in claim 10, wherein the antenna device has a return loss performance of above −10 dB.

16. The positioning device as claimed in claim 10, wherein the antenna device has a return loss performance of above −10 dB with a metal object being disposed adjacent to the antenna device having a gap distance of 2 cm therebetween.

17. The positioning device as claimed in claim 10, wherein the tracked object is a smartphone, a power loss of 5 dB is achieved at a positioning distance of 1.5 meter between the smartphone and the positioning device, in which an angular operating range of the smartphone being from 0 degrees to 360 degrees.
